(19) United States
(12) Patent Application Publication
(10) Pub. No.: US 2005/0110462 A1
(43) Pub. Date: May 26, 2005

(54) Power charger and rechargeable battery system

(76) Inventors: Walter Ullrich, Katonah, NY (US); Austin Ekeinde, Bethel, CT (US); Ken Chisholm, Dorset (GB)

Correspondence Address: KENYON & KENYON, ONE BROADWAY, NEW YORK, NY, 10004, US

(21) Appl. No.: 10/966,797

(22) Filed: Oct. 14, 2004

Related U.S. Application Data
(60) Provisional application No. 60/519,927, filed on Nov. 13, 2003.

(51) Int. Cl. H02J 7/04

(52) U.S. Cl. 320/128

(57) ABSTRACT

A rechargeable battery including intelligent switching circuitry and sensing circuitry configured to sense an input voltage from a charger. Upon connection of the charger to the battery, the battery is configured to: (i) disconnect output from battery cells in the battery to an electronic device connected to the battery, (ii) power the electronic device directly via the input voltage from the charger, and (iii) connect the rechargeable battery cells to the input voltage from the charger.

### FIELD OF THE INVENTION

The present invention relates to a rechargeable battery and battery charger system. More particularly, the invention relates to a rechargeable battery having a switching circuit and a battery charger system capable of charging the rechargeable battery while simultaneously supplying power to an electrical device, normally powered by the rechargeable battery when the battery is not being charged.

### BACKGROUND INFORMATION

Rechargeable batteries are widely used in powering electronic devices. Rechargeable batteries used to power portable radios, for example, may be charged by a battery charger while connected to the radio. Presently, if the radio is operated while the rechargeable battery and charger are connected the power to operate the radio in the standby, receive, and transmit modes is drawn directly from the rechargeable battery. As a result, the rechargeable battery is discharged to the extent necessary to power the radio while in the charging state, which leads to premature battery cell failure over time and reduces the likelihood that upon disconnection of the charger the full capacity of the rechargeable battery will be available for powering of the device. The present invention overcomes these disadvantages of the prior art by providing for intelligent switching circuitry in the battery, which causes the radio to be independently powered by the charger during charging as opposed to by the battery.

While current rechargeable batteries and charging systems may be suitable for the particular purpose employed, or for general use, they are not as suitable for the purposes of the present invention as disclosed hereafter.

### SUMMARY

An exemplary embodiment of the present invention includes a rechargeable battery, including intelligent switching circuitry, and a charging system for charging the rechargeable batteries. The charging system may act as a dual power supply and provides power to charge both the rechargeable battery and an electrical device, e.g., a radio, connected to the battery, simultaneously and independent of each other. When the rechargeable battery is attached to the electronic device and the charger is connected to the rechargeable battery, the charger independently charges the rechargeable battery as if in an OEM charger. If the electronic device is operating during charging of the battery, it is powered by an independent system circuit that does not interrupt the rechargeable battery charging and draws its power from the charger, not the rechargeable battery. This eliminates the need to draw current from the rechargeable battery while charging it, which improves the performance and life of the rechargeable battery.

The dual power charging system may be designed to operate in vehicles through a standard automotive cigarette lighter outlet as an input or with 110 Volts AC input from an AC outlet.

The rechargeable battery is configured to sense an input voltage from the charger and is further configured to: (i) disconnect output from the rechargeable battery cells to the electronic device upon sensing the input voltage from the charger, (ii) power the electronic device directly via the input voltage from the charger, and (iii) connect the rechargeable battery cells to the input voltage from the charger. The rechargeable battery cells are charged via the charger voltage being monitored through the rechargeable battery protection circuit till end of charge. The electronic device may continue to draw its power from the charger system until the connection is broken between the rechargeable battery under charge and the charger. At this point the rechargeable battery power is restored to the electronic device.

A rechargeable battery of an exemplary embodiment of the present invention is connectable to a device and a separate charger. The rechargeable battery is configured such that (i) the rechargeable battery is chargeable by the charger in a first state in which the rechargeable battery and charger are connected, (ii) the charger powers the device directly in the first state, (iii) it does not power the device in the first state, and (iv) it powers the device in a second state in which the rechargeable battery and charger are not connected and the device and rechargeable battery are connected.

In an exemplary embodiment of the present invention the rechargeable battery may include a rechargeable battery power source contained in a housing. The charger may power the device directly in the first state through the battery housing connected between the charger and the device.

In an exemplary embodiment of the present invention the rechargeable battery may further include a rechargeable power source and switching circuitry. In the first state upon input of a voltage from the charger to the rechargeable battery the switching circuitry may be configured to interrupt an output from the rechargeable power source to the device, allow power to flow from the charger to the device, and to connect the rechargeable power source to the voltage from the charger.

In an exemplary embodiment of the present invention the device powered by the rechargeable battery is an electronic device, e.g., a portable electronic device, such as a radio.

In an exemplary embodiment of the present invention the rechargeable battery is chargeable by a dual power charger.

In an exemplary embodiment of the present invention the rechargeable battery includes a rechargeable battery source, e.g., battery cells, and a protection circuit configured to monitor the rechargeable power source till end of charge. The rechargeable battery may also include circuitry to sense the presence of an input voltage from the charger.

In an exemplary embodiment of the present invention the rechargeable battery includes a temperature sensor configured to sense the temperature of the battery.

In an exemplary embodiment of the present invention the rechargeable battery includes circuitry configured to disconnect the charger from the rechargeable power source when the temperature inside the battery housing is outside a predetermined temperature range.

In an exemplary embodiment of the present invention the rechargeable battery includes circuitry configured to disconnect the rechargeable power source from the device when an output voltage of the rechargeable power source is outside a predetermined voltage range.

In an exemplary embodiment of the present invention the rechargeable battery may include switching circuitry including a first switch between the input voltage of the charger and the device, a second switch between the input voltage and the rechargeable power source, and a third switch between the rechargeable power source and the device. The first, second and third switches may be configured, for example, to allow current to pass through only when they are on. A controller may be used to control the switches.

In an exemplary embodiment of the present invention the rechargeable battery includes a controller configured to prevent the third switch from turning on if the rechargeable power source is at least one of outside a predetermined temperature range and above a predetermined voltage.

In an exemplary embodiment of the present invention the rechargeable battery includes a controller configured to turn on both the first and second switches whenever the charger is connected to the rechargeable battery.

In an exemplary embodiment of the present invention the rechargeable battery includes a controller configured to turn off the third switch whenever the charger is connected to rechargeable battery.

An exemplary embodiment of the present invention includes a rechargeable battery and charger system. The system includes a rechargeable battery configured to power a device connectable to the rechargeable battery and a charger configured to charge the rechargeable battery. The rechargeable battery is configured (i) to be chargeable by the charger in a first state in which the rechargeable battery and charger are connected, (ii) to allow the charger to power the device directly in the first state, (iii) not to power the device in the first state and (iv) to power the device in a second state in which the battery and charger are not connected and the device and rechargeable battery are connected.

In an exemplary embodiment of the present invention the rechargeable battery is configured to allow the charger to power the device directly in the first state through a housing of the rechargeable battery.

In an exemplary embodiment of the present invention the charger comprises one of a AC/DC wall adapter input source and a DC supply input source from a vehicle cigarette lighter.

In an exemplary embodiment of the present invention the charging system includes charge status indicators.

In an exemplary embodiment of the present invention the charger comprises a controller configured to regulate a voltage set point and charging current of the charger.

In an exemplary embodiment of the present invention the charger includes a controller configured to monitor the total current drawn from an input source.

In an exemplary embodiment of the present invention the charger includes a linear regulator configured to regulate a supply input.

In an exemplary embodiment of the invention, the invention includes a method for charging a rechargeable battery using a rechargeable battery and charger system. The system includes a rechargeable battery configured to power a device connectable to the rechargeable battery and a charger configured to charge the rechargeable battery. The method includes the step of connecting the charger to the rechargeable battery, using the charger to charge the rechargeable battery and to power the device when the rechargeable battery and charger are connected, and preventing the rechargeable battery from powering the device when the charger is connected to the rechargeable battery.

Example embodiments of the present invention may be embodied in the form illustrated in the accompanying drawings. Attention is called to the fact, however, that the drawings are illustrative only. Variations are contemplated as being part of the present invention, limited only by the scope of the appended claims.

### BRIEF DESCRIPTION OF THE DRAWINGS

In the drawings, like elements are depicted by like reference numerals. The drawings are briefly described as follows.

FIG. 1 is a block diagram of an exemplary embodiment of the present invention with both AC and DC power inputs to the charger.

FIG. 2 is the block diagram of FIG. 1 showing internal block components.

FIG. 3 is a block diagram of an exemplary embodiment of the present invention with a standard automotive cigarette lighter input to the charger.

FIG. 4 is a circuit block diagram of the electronic device, charging system and battery of FIGS. 1 and 2.

FIG. 5 is a table of the switch states of the switching circuitry internal to the rechargeable battery.

### DETAILED DESCRIPTION

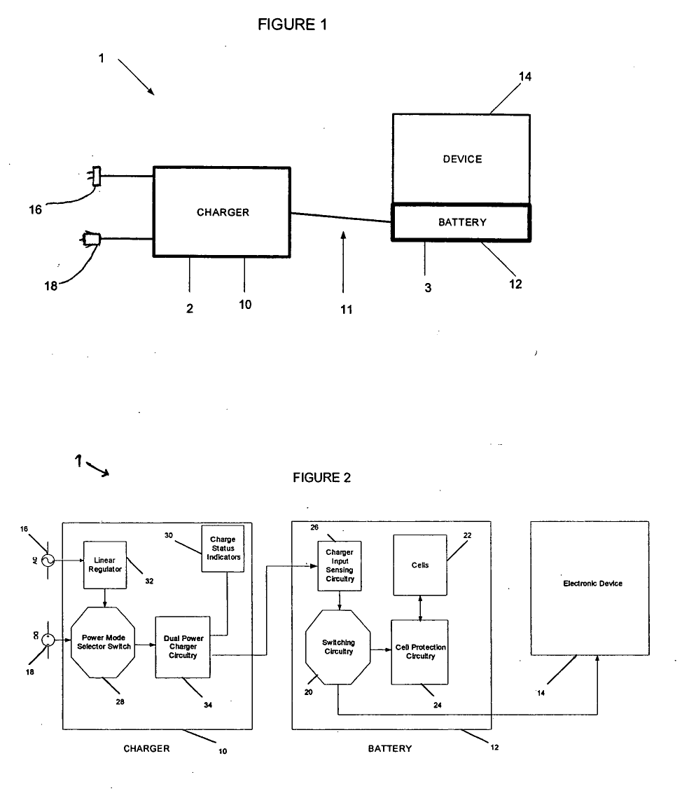

FIG. 1 is a highly schematic block diagram of an exemplary embodiment of a charger and rechargeable battery system of the present invention, generally designated 1. The system 1 includes a rechargeable battery 12 and charger 10. The rechargeable battery 12 may be used to power an electronic device 14, such as a radio, cellular phone, computer, etc., via a cable assembly 11. The charger 10 includes both an AC power input 16 and DC standard automotive cigarette lighter input 18.

In one exemplary embodiment of the invention the electronic device 14 is a portable radio, which operates, for example, from a 6V to 8.4V rechargeable battery supply or a fixed 8.4V supply, which is regulated down from an 110V AC input or a 12V automobile supply.

FIG. 2 shows the internal block components of the rechargeable battery 12 and charger 10. The rechargeable battery 12 includes switching circuitry 20, battery cells 22 and charger input sensing circuitry 26. The rechargeable battery 12 may optionally further include cell protection circuitry 24, as detailed further below.

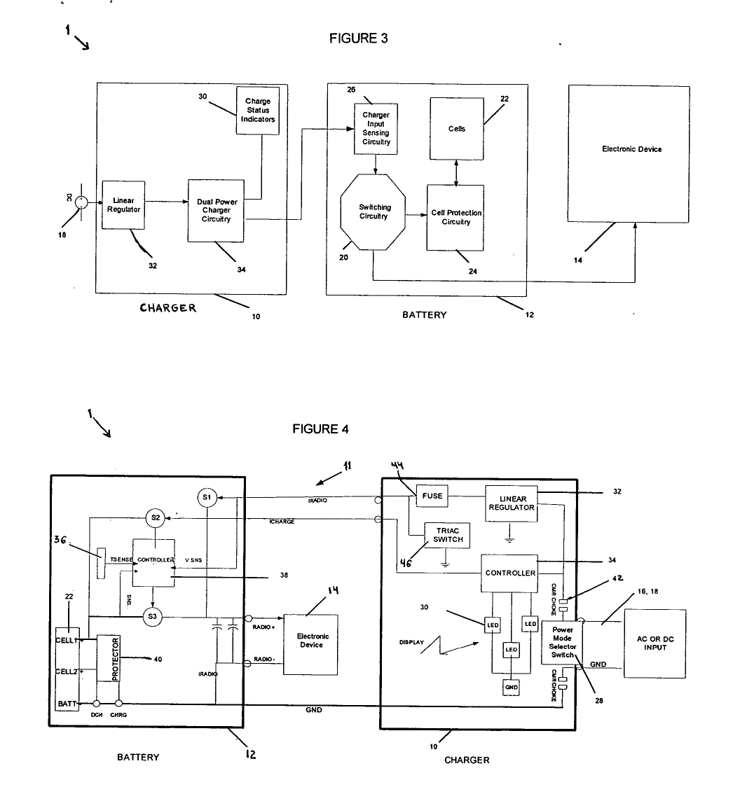

The charger 10 may optionally be configured as a dual power charging system with both AC and DC power inputs, 16 and 18, selectable via an input power mode switch 28, as shown in FIG. 2, or with a single DC power input 18, e.g., a standard automotive cigarette lighter input, as shown in FIG. 3. Power inputs 16, 18 may be regulated via linear regulator 32. The charger 10 may provide a constant voltage and constant current and may also provide for taper termination and timer safety. The charger 10 may have common mode choke inductors 42 (FIG. 4) as well as a low ESR, e.g., 100 uF, across input with an over voltage/reverse polarity diode protection (not shown separately), for example, set to 15V.

FIG. 4 is a circuit block diagram of the power charger 10 and the rechargeable battery 12, connected to the electronic device 14. The charger 10 includes the input power mode selector switch 28, status indicator lights, such as LEDs 30 (FIG. 4), linear regulator 32 and charger controller 34. A housing or enclosure 2 for the charger 10 may have vents, for example, for power dissipation of the linear regulator 32. Similarly, rechargeable battery 12 may also be enclosed in a housing 3. Linear regulator 32 may be connected to a fuse 44 and triac switch 46.

In one exemplary embodiment, controller 34 may include a MAX1737 controller chip manufactured by Maxim Dallas Semiconductors. The controller 34 regulates the charger voltage set point and charging current and monitors the total current drawn from input sources 16, 18 to prevent overload of input sources 16, 18. The input sensing circuitry 26 includes a charger power sense line, labeled SNS, input to controller 38 in the battery 12.

The battery cells 22 include a first and second cell, labeled CELL1 and CELL 2, in series. However, a different number and other configurations of cells may be used, for example, cells in series may be placed in parallel, i.e., in a series-parallel configuration.

The charger 10 is connected to the rechargeable battery 12 via three conductor cable assembly 11, including lines labeled IRADIO, ICHARGE and a GROUND. IRADIO is used to power the device 14 connected to the battery 12 and ICHARGE is used to charge the battery cells 22 in the battery 12. The charger 10 and battery 12 may share a common ground.

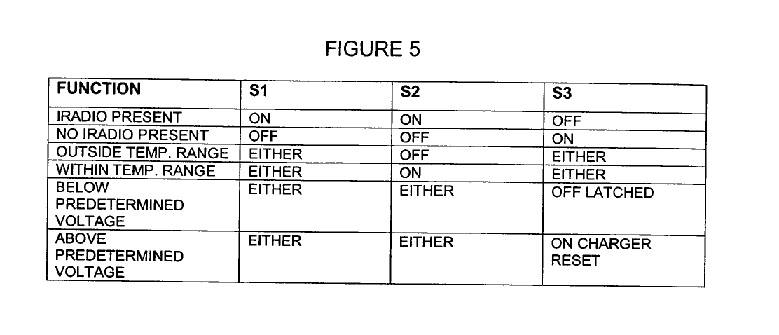

Switching circuitry 20 includes switches labeled S1, S2, and S3 controlled by controller 38. In one exemplary embodiment, controller 38 may include a MAX1737 controller chip manufactured by Maxim Dallas Semiconductors. The states of switches S1, S2, and S3 under various conditions are listed in the table of FIG. 5.

Either AC input voltage 16 or DC input voltage 18, e.g., 110V, is selectable via power mode selector switch 28 and supplied to the charger 10. The charger 10 regulates the supply input via linear regulator 32. When the charger 10 is plugged into the rechargeable battery 12 with the electronic device 14 attached, the input sensing circuitry 26 in the rechargeable battery 12 immediately senses an input voltage, ICHARGE and/or IRADIO, from the charger 10. The switching circuitry 20, including controller 38, is then configured to responsively: (i) turn off S3 so as to disconnect output from the rechargeable battery cells 22 to the electronic device 14, (ii) turn S1 on so as to power the electronic device 14 directly through the charger 10, via line IRADIO, and (iii) turn S2 on so as to connect the rechargeable battery cells 22 to the charger voltage, i.e., connect the battery cells 22 to the ICHARGE line. The rechargeable battery cells 22 are charged via the charger voltage and monitored through the rechargeable battery protection circuitry 24 (FIG. 3) till end of charge. The charger 10 may supply, for example, between 5 and 10 Volts to the battery 12.

In an exemplary embodiment of the invention the switching speeds for S1-S3 are the same. Controller 38 is configured to turn both S1 and S2 on whenever the charger 10 is connected to the battery 12, thus allowing power to flow directly from the charger 10 to the electronic component 14 via switch S1 and from the charger 10 to the battery cells 22 via switch S2 for charging purposes. When charger 10 is connected to battery 12 switch S3 is always off, i.e., the battery cells 22 are disconnected from the electronic device 14, and thus, do not supply power to the electronic device 14. When charger 10 is not connected to the rechargeable battery 12 controller 38 keeps switch S3 on allowing battery cells 22 to power the electronic device 14.

Additional limitations for switching S3 on may be imposed as well. For example, for safety reasons the controller 38 may be configured to only allow S3 to turn on only if the battery cells 22 are within a predetermined temperature range and/or above a predetermined voltage. For this purpose, the controller 38 may include a MAX931 comparator chip, manufactured by Maxim Dallas Semiconductors.

For lithium-ion batteries, an exemplary temperature range is above 0 degrees Celsius and below 55 degrees Celsius and an exemplary minimum voltage is 6V (or 3 Volts per cell). A battery power sense line, labeled VSNS, between the battery cells 22 and the controller 38 may be provided so as to monitor whether the cell voltage is low, e.g., below 6V. In cases where the voltage is low, the controller 38 may close S3, disconnecting the electronic device 14 from the battery cells 22.

In the case of low 6V the rechargeable battery (12) may be required to latch reset. If the temperature falls outside the predetermined range controller 38 may turn off switch S3 and if the temperature returns within the predetermined range switch S3 may automatically be switched back on, provided the charger 12 is not connected.

A thermistor 36, connected to the controller 38 via a TSENSE line, may be provided for temperature sensing of the entire battery 10. The thermistor 36 may include, for example, a NTC driving charge inhibit MOSFET. If the temperature of the battery 12 rises above a predetermined threshold controller 38 may turn off S2 so as to prevent further charging of the battery cells 22.

The cell protection circuitry 24 (FIG. 3) includes a cell protector 40, which provides for over and under current protection, over and under voltage protection and reverse polarity protection. Protector 40 may include, for example, a battery protection integrated circuit, such as the S8232 series of battery protection integrated circuits, manufactured by Seiko Instruments Inc. The cell protector 40 disconnects the battery cells 22 if an unsafe condition exists, e.g., when the cell voltage, current and/or temperature are outside a predetermined range. The protector 40 may include a separate thermistor (not shown) for monitoring the temperature of the battery cells 22. The cell protector 40 may also provide for taper termination and timer safety.

As many apparently widely different embodiments of the present invention may be made without departing from the spirit and scope thereof, it is to be understood that the present invention is not limited to the specific embodiments thereof except as defined in the appended claims.

1. A rechargeable battery connectable to a device and a separate charger, the rechargeable battery configured such that (i) the rechargeable battery is chargeable by the charger in a first state in which the rechargeable battery and charger are connected, (ii) the charger powers the device directly in the first state, (iii) it does not power the device in the first state, and (iv) it powers the device in a second state in which the rechargeable battery and charger are not connected and the device and rechargeable battery are connected.

2. The rechargeable battery of claim 1, further comprising a rechargeable battery power source contained in a housing, the charger powers the device directly in the first state through the battery housing connected between the charger and the device.

3. The rechargeable battery of claim 1, further comprising a rechargeable power source and switching circuitry, in the first state upon input of a voltage from the charger to the rechargeable battery said switching circuitry configured to interrupt an output from the rechargeable power source to the device, allow power to flow from the charger to the device, and to connect the rechargeable power source to the voltage from the charger.

4. The rechargeable battery of claim 1, wherein the device is an electronic device.

5. The rechargeable battery of claim 1, wherein the device is a radio.

6. The rechargeable battery of claim 1, wherein the charger is a dual power charger.

7. The rechargeable battery of claim 1, wherein the battery further includes a rechargeable battery source and a protection circuit configured to monitor the rechargeable power source till end of charge.

8. The rechargeable battery of claim 3, wherein the rechargeable power source comprises battery cells.

9. The rechargeable battery of claim 3, wherein the switching circuitry comprises a first switch between the input voltage of the charger and the device, a second switch between the input voltage and the rechargeable power source, and a third switch between the rechargeable power source and the device, the first, second and third switches are configured to allow current to pass through only when they are on.

10. The rechargeable battery of claim 1, further comprising circuitry configured to sense the presence of an input voltage from the charger.

11. The rechargeable battery of claim 1, wherein the rechargeable battery includes a temperature sensor configured to sense the temperature of the battery.

12. The rechargeable battery of claim 2, wherein the battery further includes circuitry configured to disconnect the charger from the rechargeable power source when the temperature inside the battery housing is outside a predetermined temperature range.

13. The rechargeable battery of claim 2, wherein the battery further includes circuitry configured to disconnect the rechargeable power source from the device when an output voltage of the rechargeable power source is outside a predetermined voltage range.

14. The rechargeable battery of claim 9, further comprising a controller configured to control the first, second and third switches.

15. The rechargeable battery of claim 14, wherein the controller is configured to prevent the third switch from turning on if the rechargeable power source is at least one of outside a predetermined temperature range and above a predetermined voltage.

16. The rechargeable battery of claim 14, wherein the controller is configured to turn on both the first and second switches whenever the charger is connected to the rechargeable battery.

17. The rechargeable battery of claim 14, wherein the controller is configured to turn off the third switch whenever the charger is connected to rechargeable battery.

18. A rechargeable battery and charger system, comprising:
a rechargeable battery configured to power a device connectable to the rechargeable battery; and
a charger configured to charge the rechargeable battery;
wherein the rechargeable battery is configured (i) to be chargeable by the charger in a first state in which the rechargeable battery and charger are connected, (ii) to allow the charger to power the device directly in the first state, (iii) not to power the device in the first state and (iv) to power the device in a second state in which the battery and charger are not connected and the device and rechargeable battery are connected.

19. The rechargeable battery and charging system of claim 18,
wherein the rechargeable battery is configured to allow the charger to power the device directly in the first state through a housing of the rechargeable battery.

20. The rechargeable battery and charging system of claim 18,
wherein the charger comprises one of a AC/DC wall adapter input source and a DC supply input source from a vehicle cigarette lighter.

21. The rechargeable battery and charging system of claim 18,
wherein the charging system includes charge status indicators.

22. The rechargeable battery and charging system of claim 18,
wherein the charger comprises a controller configured to regulate a voltage set point and charging current of the charger.

23. The rechargeable battery and charger system of claim 22,
wherein the controller is further configured to monitor the total current drawn from an input source.

24. The rechargeable battery and charger system of claim 18,
wherein the charger comprises a linear regulator configured to regulate a supply input.
